(19) United States
(12) Patent Application Publication
(10) Pub. No.: US 2024/0013586 A1
(43) Pub. Date: Jan. 11, 2024

(54) IN-VEHICLE DEVICE, VEHICLE NETWORK SYSTEM, DATA SYNCHRONIZATION METHOD

(71) Applicant: DENSO CORPORATION, Kariya-city (JP)

(72) Inventor: Koichiro TAKEUCHI, Kariya-city (JP)

(21) Appl. No.: 18/347,621

(22) Filed: Jul. 6, 2023

(30) Foreign Application Priority Data
Jul. 8, 2022 (JP) 2022-110648

(51) Int. Cl. G07C 5/00; G06F 16/178

(52) U.S. Cl. CPC G07C 5/008; G06F 16/178

(57) ABSTRACT

By an in-vehicle device mounted on a vehicle or a data synchronization method, primary data is acquired from a control device of the vehicle or an expansion device, the primary data is stored, a first application program is executed, and a second application program is executed to utilize secondary data or request synchronization.

### CROSS REFERENCE TO RELATED APPLICATION

The present application claims the benefit of priority from Japanese Patent Application No. 2022-110648 filed on Jul. 8, 2022. The entire disclosure of the above application is incorporated herein by reference.

### TECHNICAL FIELD

The present disclosure relates to a technology for utilizing data in a vehicle network system.

### BACKGROUND

An in-vehicle information utilization network system of a comparative example includes an in-vehicle network system, an inspection system, an in-vehicle information communication device, a mobile computer, a server device, and a client device. The in-vehicle information communication device receives in-vehicle data from the in-vehicle network system and the inspection system, and transmits the received in-vehicle data to the mobile computer by short-range communication. The mobile computer transmits the in-vehicle data to the server device by telecommunication.

### SUMMARY

By an in-vehicle device mounted on a vehicle or a data synchronization method, primary data is acquired from a control device of the vehicle or an expansion device, the primary data is stored, a first application program is executed, and a second application program is executed to utilize secondary data or request synchronization.

### BRIEF DESCRIPTION OF DRAWINGS

FIG. 1 is a diagram showing a schematic configuration of a vehicle network system.

FIG. 2 is a diagram showing a hardware configuration of an in-vehicle device.

FIG. 3 is a diagram showing a hardware configuration of a management server.

FIG. 4 is a diagram showing a hardware configuration of first and second service servers.

FIG. 5 is a diagram showing a synchronization process of primary data in the vehicle network system.

FIG. 6 is a diagram showing a part of the synchronization process of secondary data in the vehicle network system.

FIG. 7 is a diagram showing a different part of the synchronization process of the secondary data in the vehicle network system.

FIG. 8 is a diagram showing a further different part of the synchronization process of the secondary data in the vehicle network system.

FIG. 9 is a diagram showing an example of primary and secondary databases.

FIG. 10 is a diagram showing a logical sum of primary data synchronization requests from a first application execution unit and a second application execution unit.

### DETAILED DESCRIPTION

In the in-vehicle information utilization network system, all in-vehicle data acquired on the network is transmitted to the server device. Therefore, the communication traffic and the utilization fee of the server device increase, and the client device may be difficult to use the in-vehicle data of the server device.

Therefore, it is conceivable that the in-vehicle information communication device executes an application program according to the use of the in-vehicle data, processes the in-vehicle data, and transmits the processed in-vehicle data to the server device. However, when the in-vehicle information communication device executes multiple application programs for multiple uses, each of the multiple applications may similarly process the in-vehicle data and transmit the similar in-vehicle data to the server. As a result, the data may not be utilized efficiently.

One example of the present disclosure provides a technology for efficiently utilizing data in a vehicle network.

According to one example embodiment, an in-vehicle device is mounted on a vehicle, and includes: a primary data acquisition unit; an in-vehicle primary database; a first application execution unit; an in-vehicle secondary database; and a second application execution unit. The primary data acquisition unit acquires primary data from a control device of the vehicle or an expansion device. An in-vehicle primary database stores the primary data acquired by the primary data acquisition unit. A first application execution unit executes a first application program to calculate secondary data from the primary data stored in the in-vehicle primary database. An in-vehicle secondary database stores the secondary data calculated by the first application execution unit. A second application execution unit executes a second application program to utilize the secondary data stored in the in-vehicle secondary database.

In the in-vehicle device according to the example embodiment, the secondary data calculated by the first application execution unit is utilized by the second application execution unit. That is, the first application execution unit and the second application execution unit do not calculate the secondary data independently, and the first application execution unit and the second application execution unit utilize the same secondary data. Therefore, it is possible to efficiently utilize data. According to another example embodiment, the vehicle network system includes: a management server that includes a server primary database and a server secondary database; a first service server that provides a first service based on primary data stored in the server primary database or secondary data stored in the server secondary database; a second service server that provides a second service based on the primary data stored in the server primary database or the secondary data stored in the server secondary database; and an in-vehicle device mounted on a vehicle. The in-vehicle device includes: a primary data acquisition unit; an in-vehicle primary database; a first application execution unit; an in-vehicle secondary database; and a second application execution unit. The primary data acquisition unit acquires primary data from a control device of the vehicle or an expansion device. The in-vehicle primary database stores the primary data acquired by the primary data acquisition unit. The first application execution unit executes a first application program to calculate secondary data from the primary data stored in the in-vehicle primary database, and the first application program is related to a first service. The in-vehicle secondary database stores the secondary data calculated by the first application execution unit. The second application execution unit executes a second application program to utilize the secondary data stored in the in-vehicle secondary database, and the second application program is related to a second service.

The vehicle network system according to another example embodiment has the similar effects to the in-vehicle device described above.

Further, according to another example embodiment, a vehicle network system includes: a management server that includes a server primary database and a server secondary database; a first service server that provides a first service based on primary data stored in the server primary database or secondary data stored in the server secondary database; a second service server that provides a second service based on the primary data stored in the server primary database or the secondary data stored in the server secondary database; and an in-vehicle device mounted on a vehicle. The in-vehicle device includes: a primary data acquisition unit; an in-vehicle primary database; a first application execution unit; a second application execution unit; and a data synchronization unit. The primary data acquisition unit acquires primary data from a control device of the vehicle or an expansion device. The in-vehicle primary database stores the primary data acquired by the primary data acquisition unit. The first application execution unit executes a first application program related to the first service based on the primary data stored in the in-vehicle primary database and requests synchronization of a first part of the primary data with the server primary database, and the first part is used by the first service server. The second application execution unit executes a second application program related to the second service based on the primary data stored in the in-vehicle primary database and requests synchronization of a second part of the primary data with the server primary database, and the second part is used by the second service server. The data synchronization unit obtains a logical sum of first part and the second part according to a primary data synchronization request from the first application execution unit and the second application execution unit, and uploads the logical sum to the server primary database. The first service server uses the first part stored in the server primary database. The second service server uses the second part stored in the server primary database.

In the vehicle network system of another example embodiment, the logical sum of the first part and the second part is obtained and uploaded to the server primary database. Thereby, it is possible to prevent the overlapping portion between the first part and the second part from being uploaded twice. As a result, it is possible to reduce the data communication traffic in the vehicle network system and the utilization fee for the server primary database. Further, the first service server can use the first part simply by sending a request from the first application execution unit to synchronize the first part with the server primary database. Further, the second service server can use the second part simply by sending a request from the second application execution unit to synchronize the second part with the server primary database.

Furthermore, according to another example embodiment, a data synchronization method includes: acquiring primary data from a control device of a vehicle or an expansion device; storing the acquired primary data in a primary database; executing a first application program to calculate secondary data from the primary data stored in the vehicle primary database; storing the calculated secondary data in a secondary database; and executing a second application program to utilize the secondary data stored in the secondary database.

### (1. System Configuration)

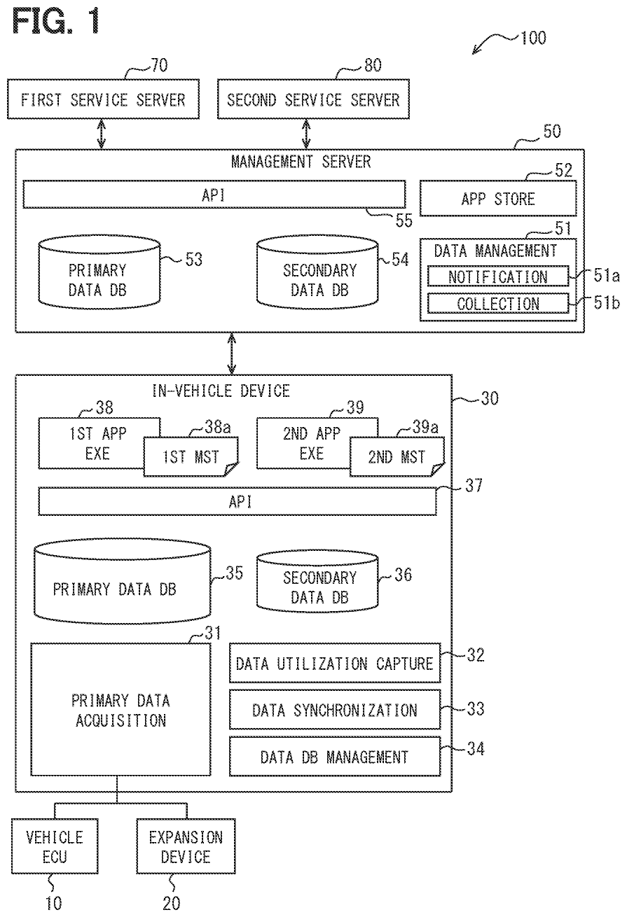

A schematic configuration of a vehicle network system 100 according to the present embodiment will be described with reference to FIG. 1. The vehicle network system 100 includes an in-vehicle device 30, a management server 50, a first service server 70, and a second service server 80. Although one in-vehicle device 30 is illustrated in FIG. 1, the vehicle network system 100 includes multiple in-vehicle devices 30. Also, the vehicle network system 100 may include additional service servers in addition to the first and second service servers 70 and 80. That is, the vehicle network system 100 may include three or more service servers.

The in-vehicle device 30 is mounted on a vehicle and collects vehicle data. The management server 50 is installed outside the vehicle, and stores primary data and secondary data uploaded from the in-vehicle device 30. The first service server uses the primary data and/or secondary data stored in the management server 50 to provide a first service to a service user. The second service server 80 uses the primary data and/or secondary data stored in the management server 50 to provide a second service to the service user. The service user is a vehicle user such as an owner or an operation manager, and the first and second services are fleet services, congestion prediction services, and the like.

### (1-1. Configuration of In-Vehicle Device)

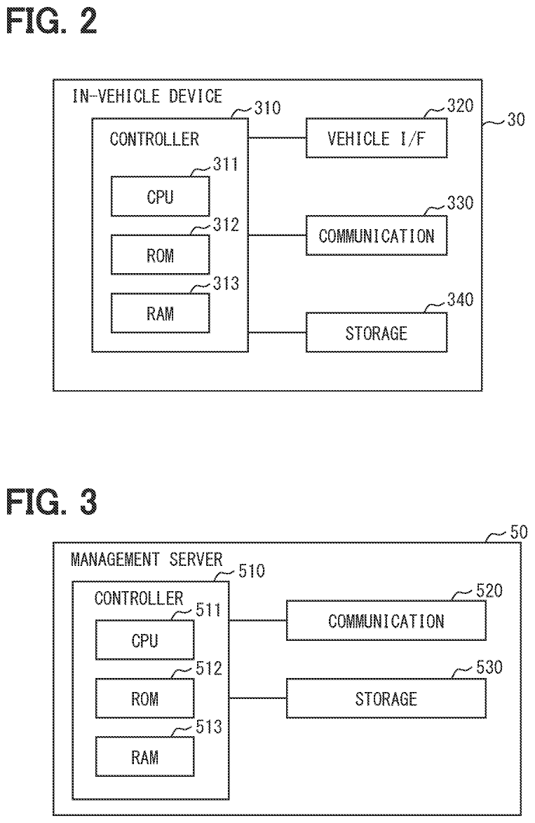

As shown in FIG. 2, the in-vehicle device 30 includes a controller 310, a vehicle interface (hereinafter referred to as vehicle I/F) 320, a communication unit 330, and a storage 340.

The controller 310 includes a CPU 311, a ROM 312, and a RAM 313. Various functions of the controller 310 are implemented by the CPU 311 executing a program stored in a non-transitory tangible storage medium. In the present embodiment, the ROM 312 corresponds to a non-transitory tangible storage medium storing programs. A method corresponding to the program is performed by executing the program.

The vehicle I/F 320 is connected to a vehicle electronic controller (hereinafter referred to as a vehicle ECU) 10 and/or an expansion device 20 via an in-vehicle network or the like of the vehicle, and acquires various data from the vehicle ECU 10 and/or the expansion device 20. The vehicle ECU 10 controls various devices, such as a brake, a steering wheel, a camera, and a radar. The expansion device 20 is an exterior device that is retrofitted to the vehicle, and for example, such an in-vehicle camera. The in-vehicle network may include CAN and Ethernet. The CAN is an abbreviation for Controller Area Network. The CAN is a registered trademark. The Ethernet is a registered trademark.

The communication unit 330 performs data communication with the management server 50 via a wide area communication network by wireless communication. The storage 340 includes a primary data database (hereinafter referred to as DB) 35 and a secondary data DB 36, and stores vehicle data and the like acquired via the vehicle I/F 320.

As shown in FIG. 1, the in-vehicle device 30 has functions of a primary data acquisition unit 31, a data utilization status capture unit 32, a data synchronization unit 33, a data DB management unit 34, an API 37, a first application execution unit 38, and a second application execution unit 39.

The primary data acquisition unit 31 repeatedly acquires vehicle primary data related to various devices from the vehicle ECU 10 and/or the expansion device at a predetermined cycle. The primary data includes vehicle data such as operation amounts of various devices received from the vehicle ECU 10 and/or the expansion device 20 and detection data detected by the various devices. The primary data includes, for example, an on-off state of brake, a vehicle speed, or a steering wheel angle. The primary data may include not only raw data but also normalized (or standardized) data so as to eliminate variations among vehicle types. The primary data acquisition unit 31 stores the acquired primary data of the vehicle in the primary data DB 35 in association with the type of the primary data and the acquisition time.

The first application execution unit 38 executes the first application program based on a first manifest 38a to calculate the secondary data from the primary data. In the drawings, the first application execution unit 38 may be also referred to as “1ST APP EXE”, and the term of manifest may be also referred to as “MST”. The first application program corresponds to the first service server 70, and is a program for calculating secondary data. The secondary data is necessary for the first service server 70 to provide the first service. The first manifest 38a describes what kind of secondary data the first application execution unit 38 should calculate from the primary data. A user of the vehicle can receive the first service from the first service server 70 by installing the first application program by the CPU 311.

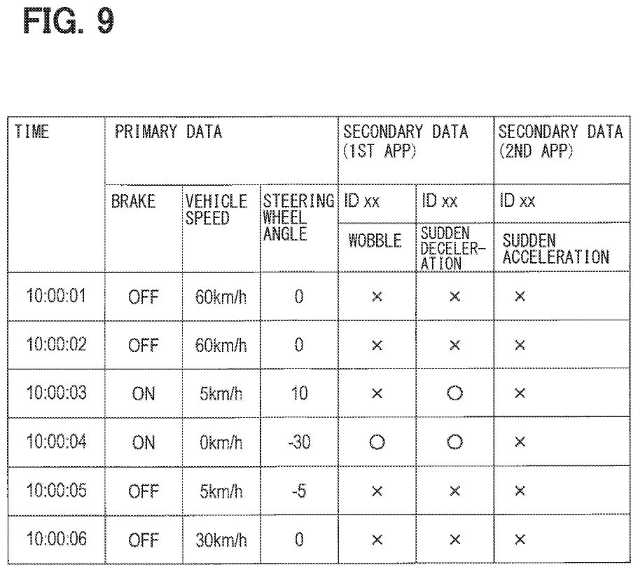

For example, as shown in FIG. 9, the first application execution unit 38 detects whether wobble of the vehicle has occurred and whether the vehicle is decelerating suddenly as secondary data from the primary data including the on-off state of the brake, the vehicle speed, and the angle of the steering wheel. The first application execution unit 38 stores the calculated secondary data in the secondary data DB 36 in association with the type of the secondary data and the acquisition time. Different identification information (hereinafter referred to as ID) is assigned to each type of secondary data. The acquisition time of the secondary data is a primary data acquisition time of the calculation source.

Similarly, the second application execution unit 39 is a program that executes the second application program based on the second manifest 39a, and calculates the secondary data necessary for the second service server 80 to provide the second service. In the drawings, the second application execution unit 39 may be also referred to as “2ND APP EXE”. The assigned application ID of the first application program is different from that of the second application program. The second manifest 39a describes what kind of secondary data the second application execution unit 39 should calculate from the primary data. A user of the vehicle can receive the first service from the second service server 80 by installing the second application program by the CPU 311.

For example, as shown in FIG. 9, the second application execution unit 39 detects whether the vehicle has suddenly started as secondary data from the primary data including the on-off state of the brake, the vehicle speed, and the angle of the steering wheel. The second application execution unit 39 stores the calculated secondary data in the secondary data DB 36 in association with the type of the secondary data and the acquisition time.

Here, the secondary data to be calculated by the second application execution unit 39 may overlap with the secondary data calculated by the first application execution unit 38. For example, the first application execution unit 38 calculates the presence or absence of sudden deceleration as secondary data, and the second application execution unit 39 uses, as secondary data, the presence or absence of sudden deceleration to calculate whether the driver is dozing. In such a situation, as compared with a case where each of the first application execution unit 38 and the second application execution unit 39 calculates the presence or absence of sudden deceleration, it is possible to more efficiently utilize the resources of the in-vehicle device 30 in a case where either one calculates the presence or absence of the sudden deceleration.

Therefore, the second application execution unit 39 does not calculate the presence or absence of sudden deceleration, and utilizes the secondary data, which shows the presence or absence of sudden deceleration, is calculated by the first application execution unit 38, and is stored in the secondary data DB 36. That is, the second application execution unit 39 refers to the first manifest 38a and the second manifest 39a to calculate necessary secondary data other than the secondary data calculated by the first application execution unit 38.

The API 37 is a standard interface for the first application execution unit 38 and the second application execution unit 39 to access the primary data DB 35 and the secondary data DB 36. The API 37 records data each time the first application execution unit 38 and the second application execution unit 39 access the secondary data DB 36, and notifies the data utilization status capture unit 32 of the utilization status of the secondary data. The utilization status corresponds to information in which the secondary data acquisition time and the data ID are associated with the application ID, and indicates which application ID uses which secondary data.

The data utilization status capture unit 32 cooperates with the API 37 to grasp the utilization status of the secondary data described above, and stores the grasped utilization status of the secondary data as a first log.

The data DB management unit 34 grasps the type of secondary data to be calculated based on the first manifest 38a and the second manifest 39a, and adds a data label according to the type of secondary data to be calculated to the secondary data DB 36. Thereby, the calculated secondary data can be stored in the secondary data DB 36. Further, the data DB management unit 34 cooperates with the API 37 to grasp the amount of data stored in the secondary data DB 36 for each data ID, and stores the grasped information as a second log.

The data synchronization unit 33 uploads at least a part of the primary data in the first data DB 35 or the secondary data in the secondary data DB 36 to the management server 50, in accordance with the primary data synchronization request or the secondary data synchronization request from the first application execution unit 38 or the second application execution unit 39. Further, the data synchronization unit 33 periodically uploads the first log and the second log to the management server 50.

### (1-2. Management Server Configuration)

As shown in FIG. 3, the management server 50 includes a controller 510, a communication unit 520, and a storage 530.

The controller 510 includes a CPU 511, a ROM 512, and a RAM 513. Various functions of the controller 510 are implemented by the CPU 511 executing a program stored in a non-transitory tangible storage medium. In this example, the ROM 512 corresponds to a non-transitory tangible storage medium storing programs. A method corresponding to the program is performed by executing the program.

The communication unit 520 wirelessly connects with the in-vehicle device the first service server 70, and the second service server 80 via the wide area communication network to perform data communication. The storage 530 includes a primary data DB 53 and a secondary data DB 54 and stores vehicle data and the like provided from the in-vehicle device 30.

As shown in FIG. 1, the management server 50 has functions of a data management unit 51, an app store 52, and an API 55. The API 55 is a standard interface for the in-vehicle device 30, the first service server 70, and the second service server 80 to access the primary data DB 53 and the secondary data DB 54. The app store 52 may be also referred to as an application storage.

The data management unit 51 collects first logs from the multiple in-vehicle device 30 connected to the vehicle network system 100 via the API 55. Then, the data management unit 51 determines which application program uses the secondary data and tallies up the number of utilizations of the secondary data utilized by the application program. That is, the data management unit 51 includes a collection unit 51b that collects the data ID and data amount of secondary data utilized for each application ID.

The app store 52 manages the first application program and distributes the first application program to the in-vehicle device 30 together with the first manifest 38a. Further, the app store 52 manages the second application program and distributes the second application program to the in-vehicle device 30 together with the second manifest 39a.

When the vehicle network system 100 includes three or more service servers, the app store 52 manages three or more application programs. Further, in the present embodiment, one service server provides one application program, but one service server may provide multiple application programs. The app store 52 manages all application programs provided by all service servers on the vehicle network system 100.

The app store 52 assigns a unique app ID to the application program it manages, and describes the app ID in the corresponding manifest. The application store 52 manages application programs in association with a service server of a provider that developed the application programs.

### (3. Service Server Configuration)

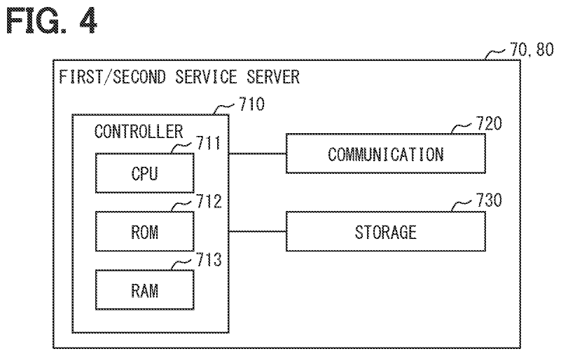

As shown in FIG. 4, each of the first and second service servers 70 and 80 includes a controller 710, a communication unit 720, and a storage 730.

The controller 710 includes a CPU 711, a ROM 712, and a RAM 713. Various functions of the controller 710 are implemented by the CPU 711 executing a program stored in a non-transitory tangible storage medium. In this example, the ROM 712 corresponds to a non-transitory tangible storage medium storing programs. A method corresponding to the program is performed by executing the program.

The communication unit 720 performs data communication with the management server 50 via a wide area communication network by wireless communication. The storage 730 stores various types of data necessary for providing services.

### (2. Process)

### (2-1. Primary Data Synchronization Process)

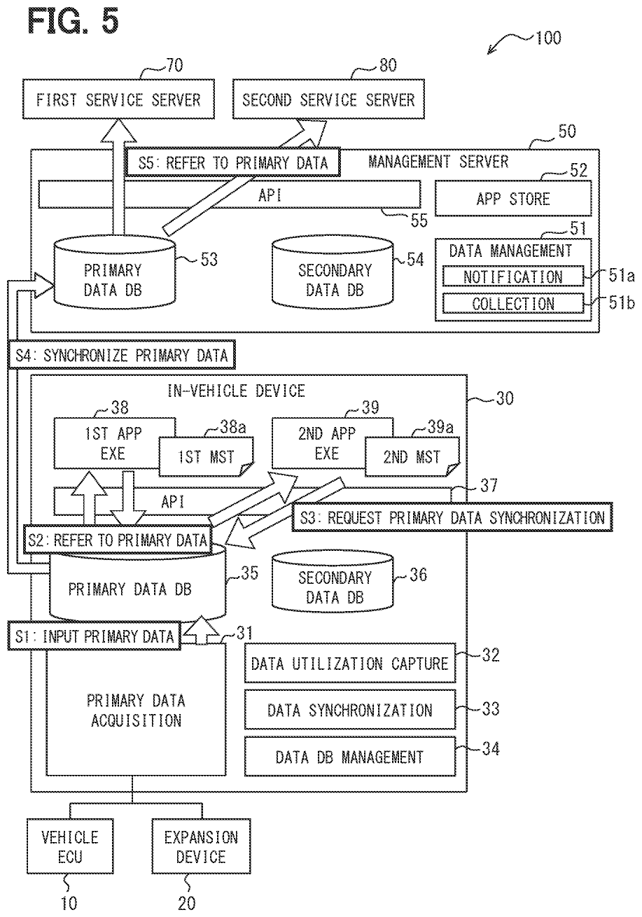

A flow of a primary data synchronization process executed by the vehicle network system 100 will be described with reference to FIG. 5. Synchronization here means storing at least part of the primary data stored in the primary data DB 35 of the in-vehicle device 30 in the primary data DB 53 of the management server 50. That is, synchronization here means maintaining the primary data DB 53 in the same state as at least part of the primary data DB 35.

First, in 51, the primary data acquisition unit 31 acquires the primary data from the vehicle ECU 10 and/or the expansion device 20 and inputs the acquired primary data to the primary data DB 35. In S2, the first application execution unit 38 accesses the primary data DB 35 via the API 37 and refers to the primary data.

In S3, the first application execution unit 38 and the second application execution unit 39 issue the primary data synchronization requests to the data synchronization unit 33 via the API 37. For example, as in an example shown in FIG. in S100, the first application execution unit 38 requests synchronization of the on-off state data of the brake at (i) 10:00:03 and (ii) 10:00:04 with the first data DB 53 of the management server 50. Further, in S110, the second application execution unit 39 requests synchronization of the on-off state data of the brake at (ii) 10:00:04 and (iii) 10:00:02 with the primary data DB 53 of the management server 50. The data utilization status capture unit 32 acquires information about which primary data synchronization has been requested by each of the first application execution unit 38 and the second application execution unit 39 via the API 37 (that is, information about the specific acquisition time and type for specifying the primary data), and stores the acquired information as primary data synchronization request information.

Next, in S4, the data synchronization unit 33 uploads the primary data to the primary data DB 53 according to the primary data synchronization request from the first application execution unit 38 and the second application execution unit 39. Specifically, the data synchronization unit 33 obtains the logical sum of a first part and a second part of the primary data stored in the primary data DB 35, and uploads the logical sum to the primary data DB 53 of the management server 50. The first part of the primary data corresponds to the primary data whose synchronization is requested by the first application execution unit 38. The second part of the primary data corresponds to the primary data whose synchronization is requested by the second application execution unit 39.

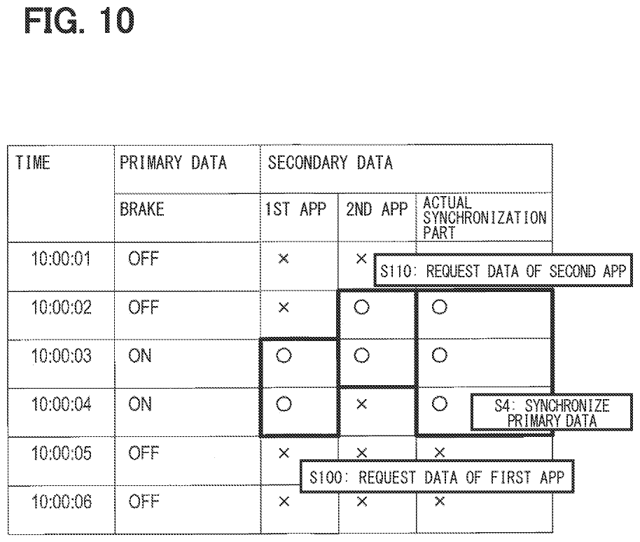

For example, in the example shown in FIG. 10, the first part corresponds to the on-off state data of the brake at (i) 10:00:03 and (ii) 10:00:04, and the second part corresponds to the on-off state data of the brake at (iii) 10:00:02 and (i) 10:00:03. Both the first application execution unit 38 and the second application execution unit 39 request synchronization of the primary data at (i) 10:00:03, and the primary data synchronization requests from both overlap. The data synchronization unit 33 does not upload the primary data at (i) 10:00:03 to the primary data DB 53 twice even when the primary data synchronization requests overlap. That is, the data synchronization unit 33 uploads the primary data at each of (ii) 10:00:04, (i) 10:00:03, and (iii) 10:00:02 to the primary data DB 53 once. The data synchronization unit 33 also uploads the primary data synchronization request information saved by the data utilization status capture unit 32 to the primary data DB 53 at the same time as the primary data.

The data synchronization unit 33 obtains the logical sum of the primary data synchronization requests of the first application execution unit 38 and the second application execution unit 39, and uploads the logical sum to the primary data DB 53. Thereby, it is possible to reduce the communication traffic.

In S5, the first service server 70 and the second service server 80 access the primary data DB 53 of the management server 50 via the API 55 and refer to the primary data. Specifically, when the primary data and the primary data synchronization request information are uploaded to the primary data DB 53, the data management unit 51 provides the notification to the first service server 70 and the second service server 80 based on the primary data synchronization request information via API 55. Specifically, the data management unit 51 notifies the first service server 70 that the primary data used by the first service server 70 has been uploaded to the primary data DB 53. The data management unit 51 notifies the second service server 80 that the primary data used by the second service server 80 has been uploaded to the primary data DB 53. Each of the first service server 70 and the second service server 80 receives the notification and accesses the primary data DB 53 via the API 55.

### (2-2. Secondary Data Synchronization Process)

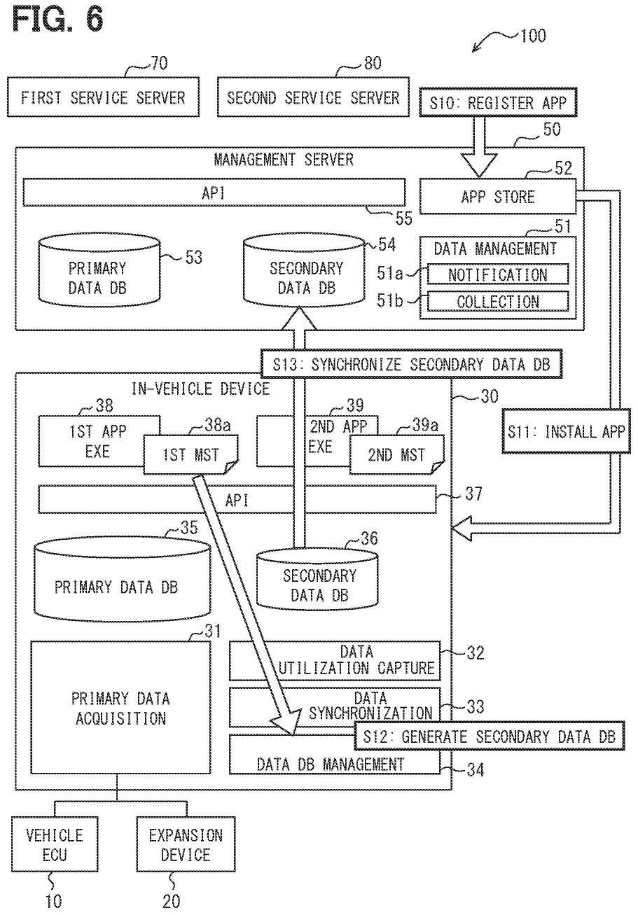

A flow of a pat of a secondary data synchronization process executed by the vehicle network system 100 will be described with reference to FIG. 6. Synchronization here means storing at least part of the secondary data stored in the secondary data DB 36 of the in-vehicle device 30 in the secondary data DB 54 of the management server 50. That is, synchronization here means maintaining the secondary data DB 54 in the same state as at least part of the secondary data DB 36.

In S10, the first service server 70 registers the first application program and the first manifest 38a necessary for the first service in the app store 52 of the management server 50. Further, the second service server 80 registers the second application program and the second manifest 39a necessary for the first service in the app store 52 of the management server 50.

In S11, the in-vehicle device 30 downloads the first application program and the first manifest 38a registered in the app store 52, and installs the first application program. Further, the in-vehicle device 30 downloads the second application program and the second manifest 39a registered in the app store 52, and installs the second application program.

In S12, the data DB management unit 34 of the in-vehicle device 30 adds data labels to the secondary data DB 36 according to the first manifest 38a and the second manifest 39a. Thereby, the secondary data calculated by the first application execution unit 38 and/or the second application execution unit 39 can be stored in the secondary data DB 36.

In S13, the data synchronization unit 33 synchronizes at least part of the secondary data stored in the secondary data DB 36 with the secondary data DB 54 of the management server 50 according to the secondary data synchronization requests from the first application execution unit 38 and/or the second application execution unit 39.

As described above, by registering a manifest together with an application program in the app store 52, one application execution unit can grasp the secondary data calculated by another application execution unit, and buy and use the secondary data calculated by another application execution unit. Consequently, it is possible to trade the secondary data between multiple service server providers via a provider of the management server 50.

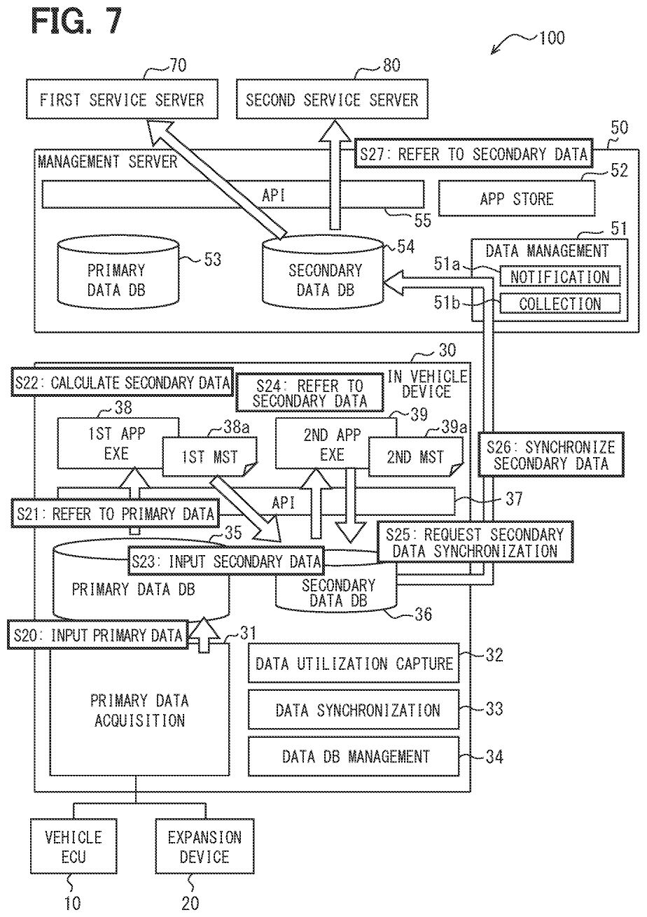

Next, a flow of a different part of the secondary data synchronization process executed by the vehicle network system 100 will be described with reference to FIG. 7. In S20, the primary data acquisition unit 31 acquires the primary data from the vehicle ECU 10 and/or the expansion device 20 and stores the acquired primary data in the primary data DB 35.

In S21, the first application execution unit 38 refers to the primary data stored in the primary data DB 35 via the API 37. In S22, the first application execution unit 38 calculates the secondary data from the referred primary data.

In S23, the first application execution unit 38 inputs the calculated secondary data to the secondary data DB 36. In S24, the second application execution unit 39 accesses the secondary data DB 36 in response to the calculation of the secondary data by the first application execution unit 38, and refers to the secondary data calculated by the first application execution unit 38.

In S25, the second application execution unit 39 issues the secondary data synchronization request to the data synchronization unit 33. The data utilization status capture unit 32 acquires information about which secondary data synchronization has been requested by each of the first application execution unit 38 and the second application execution unit 39 via the API 37 (that is, information about the specific acquisition time and data ID for specifying the secondary data), and stores the acquired information as the secondary data synchronization request information. In other words, the data utilization status capture unit 32 acquires information indicating synchronization target data, and stores the acquired the information as the secondary data synchronization request information.

In S26, the data synchronization unit 33 uploads at least a part of secondary data stored in the secondary data DB 36 to the secondary data DB 54 of the management server 50 in responds to storing the secondary data in the secondary data DB 36 or the secondary data synchronization request. The data synchronization unit 33 may upload the secondary data to the secondary data DB 54 each time the secondary data is stored in the secondary data DB 36 or each time a secondary data synchronization request is received, or may collectively upload the secondary data to the secondary data DB 54 periodically. The data synchronization unit 33 also uploads the secondary data synchronization request information saved by the data utilization status capture unit 32 to the secondary data DB 54 at the same time as the secondary data. Further, when receiving the secondary data synchronization request from the first application execution unit 38 and the second application execution unit 39 in the same manner as the synchronization of the primary data, the data synchronization unit 33 may obtain the logical sum of the secondary data synchronization requests, and upload the logical sum to the secondary data DB 54.

In S27, the first service server 70 and the second service server 80 access the secondary data DB 54 of the management server 50 via the API 55 and refer to the secondary data. Specifically, when the secondary data and the secondary data synchronization request information are uploaded to the secondary data DB 54, the data management unit 51 notifies the first service server 70 and the second service server 80 of the upload based on the secondary data synchronization request information via API 55. The data management unit 51 includes a notification unit that notifies the first service server 70 that the secondary data used by the first service server 70 has been uploaded to the secondary data DB 54. The data management unit 51 notifies the second service server 80 that the secondary data used by the second service server 80 has been uploaded to the secondary data DB 54. Each of the first service server 70 and the second service server 80 receives the notification, and accesses the secondary data DB 54 via the API 55.

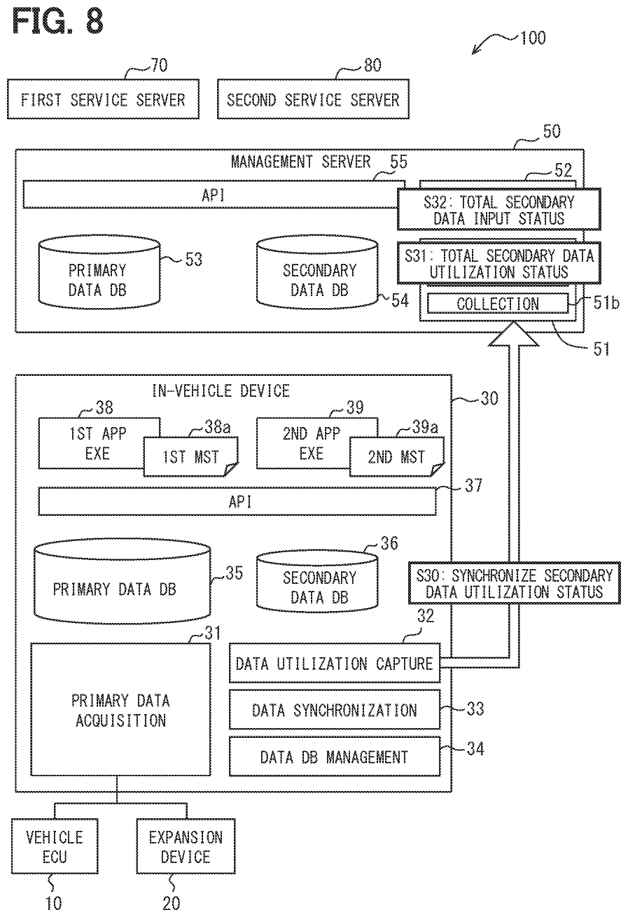

Next, a flow of a further different part of the secondary data synchronization process executed by the vehicle network system 100 will be described with reference to FIG. 8. In S30, the data utilization status capture unit 32 aggregates the secondary data utilization records of the first application execution unit 38 and the second application execution unit 39, and uploads the aggregated secondary data utilization records to the data management unit 51 of the management server 50. The secondary data utilization record indicates the data ID and data amount used by each of the first application execution unit 38 and the second application execution unit 39.

In S31, the data management unit 51 receives secondary data utilization records from the multiple in-vehicle devices 30, and totals the secondary data utilization records of the multiple in-vehicle devices 30. That is, the amount of data in the multiple in-vehicle devices 30 is totaled for each data ID of the secondary data.

In S32, the data management unit 51 acquires the input status of the secondary data at the timing when the data synchronization unit 33 uploads the secondary data calculated by the first application execution unit 38 to the secondary data DB 54. The data management unit 51 totals the input status of the secondary data of the multiple in-vehicle devices 30. The input status of secondary data indicates the data ID and data amount of the secondary data input to the secondary data DB 36.

As described above, by totaling the utilization status and input status of secondary data among multiple in-vehicle devices 30, it is possible to capture the amount of secondary data transferred between multiple service server providers. Accordingly, it is possible to trade the secondary data between multiple service server providers via the management server 50.

### (3. Effects)

According to the first embodiment described in detail above, the following effects are achieved.
(1) The secondary data calculated by the first application execution unit 38 is used by the second application execution unit 39. That is, the first application execution unit 38 and the second application execution unit 39 do not calculate the secondary data independently, and the first application execution unit 38 and the second application execution unit 39 utilize the same secondary data. Therefore, it is possible to efficiently utilize data.
(2) The data utilization status capture unit 32 captures the utilization status of the secondary data, so that it is possible to trade the secondary data among multiple service servers.
(3) The logical sum of the primary data synchronization requests of the first application execution unit 38 and the second application execution unit 39 is uploaded to the primary data DB 53. Thereby, it is possible to prevent the same primary data from being uploaded twice to the primary data DB 53. As a result, it is possible to reduce the data communication traffic in the vehicle network system 100 and the utilization fee for the primary data DB 53.
(4) The first application execution unit 38 can transmit the secondary data used by the first service server 70 to the first service server 70 by inputting the secondary data into the secondary data DB 36.
(5) The primary data synchronization request information is uploaded to the primary data DB 53. Thereby, each of the first service server 70 and the second service server 80 can know that the primary data required by itself has been uploaded to the primary data DB 53.
(6) The first manifest 38a and the second manifest 39a are downloaded from the app store 52 to the in-vehicle device 30, and the data labels are added to the secondary data DB 36 based on the first manifest 38a and the second manifest 39a. Thereby, the calculated secondary data can be stored in the secondary data DB 36.

### OTHER EMBODIMENTS

Although the embodiment of the present disclosure has been described above, the present disclosure is not limited to the embodiment described above, and various modifications can be made to implement the present disclosure.
(a) The controllers 310, 510, and 710 and methods thereof described in the present disclosure may be implemented by a dedicated computer provided by configuring a processor and a memory programmed to execute one or more functions embodied by a computer program. Alternatively, the controllers 310, 510, and 710 and methods thereof described in the present disclosure may be implemented by a dedicated computer provided by configuring the processor with one or more dedicated hardware logic circuits. Alternatively, the controllers 310, 510, and 710 and methods thereof described in the present disclosure may be implemented by one or more dedicated computers configured with a combination of a processor and a memory programmed to execute one or more functions, and a processor configured with one or more hardware logic circuits. The computer program may be stored in a computer-readable non-transitory tangible storage medium as instructions to be executed by the computer. The methods of implementing the function of each part included in the controllers 310, 510, and 710 do not necessarily include software, and all the functions may be implemented using one or more pieces of hardware.
(b) Multiple functions of one element in the above embodiments may be implemented by multiple elements, or one function of one element may be implemented by multiple elements. Further, multiple functions of multiple elements may be implemented by one element, or one function implemented by multiple elements may be implemented by one element. A part of the configuration of the above embodiment may be omitted as appropriate. At least a part of the configuration in one embodiment may be added to or substituted for the configuration of another embodiment.
(c) The present disclosure may be implemented by, in addition to the in-vehicle device and the vehicle network system described above, various forms such as a program causing a computer to function as the in-vehicle device, a non-transitory tangible storage medium including a semiconductor memory storing the program, and a data synchronization method of the vehicle network.

Here, the process of the flowchart or the flowchart described in this application includes a plurality of sections (or steps), and each section is expressed as, for example, S11. Further, each section may be divided into several subsections, while several sections may be combined into one section. Furthermore, each section thus configured may be referred to as a device, module, or means.

1. An in-vehicle device mounted on a vehicle, the device comprising:
a primary data acquisition unit configured to acquire primary data from a control device of the vehicle or an expansion device;
an in-vehicle primary database configured to store the primary data acquired by the primary data acquisition unit;
a first application execution unit configured to execute a first application program to calculate secondary data from the primary data stored in the in-vehicle primary database;
an in-vehicle secondary database configured to store the secondary data calculated by the first application execution unit; and
a second application execution unit configured to execute a second application program to utilize the secondary data stored in the in-vehicle secondary database.

2. The in-vehicle device according to claim 1, further comprising
a utilization status capture unit configured to capture a utilization status of the secondary data stored in the in-vehicle secondary database.

3. The in-vehicle device according to claim 1, wherein
the first application execution unit is configured to request synchronization of a first part of the primary data stored in the in-vehicle primary database with a server primary database of a management server,
the second application execution unit is configured to request synchronization of a second part of the primary data stored in the in-vehicle primary database with the server primary database, and
the in-vehicle device further includes a data synchronization unit configured to
obtain a logical sum of the first part and the second part according to a primary data synchronization request from the first application execution unit and the second application execution unit, and
upload the logical sum to the server primary database.

4. The in-vehicle device according to claim 3, wherein
the data synchronization unit is configured to upload, to a server secondary database of the management server, at least a part of the secondary data stored in the in-vehicle secondary database according to a secondary data synchronization request from the first application execution unit or the second application execution unit.

5. The in-vehicle device according to claim 3, wherein
the in-vehicle primary database stores a type of the primary data and an acquisition time of the primary data in association with the primary data, and
the data synchronization unit is configured to
upload, to the server primary database, primary data synchronization request information indicating
the type and the acquisition time corresponding to the first part in association with the first application program and also
the type and the acquisition time corresponding to the second part in association with the second application program.

6. A vehicle network system comprising:
a management server including a server primary database and a server secondary database;
a first service server configured to provide a first service based on primary data stored in the server primary database or secondary data stored in the server secondary database;
a second service server configured to provide a second service based on the primary data stored in the server primary database or the secondary data stored in the server secondary database; and
an in-vehicle device mounted on a vehicle,
wherein
the in-vehicle device includes:
a primary data acquisition unit configured to acquire primary data from a control device of the vehicle or an expansion device;
an in-vehicle primary database configured to store the primary data acquired by the primary data acquisition unit;
a first application execution unit configured to execute a first application program to calculate secondary data from the primary data stored in the in-vehicle primary database, the first application program being related to the first service;
an in-vehicle secondary database configured to store the secondary data calculated by the first application execution unit; and
a second application execution unit configured to execute a second application program to utilize the secondary data stored in the in-vehicle secondary database, the second application program being related to the second service.

7. The vehicle network system according to claim 6, wherein
the in-vehicle device further includes a utilization status capture unit configured to capture a utilization status of the secondary data stored in the in-vehicle secondary database.

8. The vehicle network system according to claim 7, wherein
the first application execution unit is configured to request synchronization of a first part of the primary data stored in the in-vehicle primary database with the server primary database,
the second application execution unit is configured to request synchronization of a second part of the primary data stored in the in-vehicle primary database with the server primary database, and
the in-vehicle device further includes a data synchronization unit configured to
obtain a logical sum of the first part and the second part according to a primary data synchronization request from the first application execution unit and the second application execution unit, and
upload the logical sum to the server primary database.

9. The vehicle network system according to claim 8, wherein
the data synchronization unit is configured to upload, to the server secondary database, at least a part of the secondary data stored in the in-vehicle secondary database according to a secondary data synchronization request from the first application execution unit or the second application execution unit.

10. The vehicle network system according to claim 8, wherein
the in-vehicle primary database stores a type of the primary data and an acquisition time of the primary data in association with the primary data, and
the data synchronization unit is configured to upload, to the server primary database, primary data synchronization request information indicating
the type and the acquisition time for the first part in association with the first application program and also
the type and the acquisition time for the second part in association with second application program.

11. The vehicle network system according to claim 6, wherein
the management server includes an application storage that stores
a first manifest indicating the first application program and a type of the secondary data generated based on the first application program and
a second manifest indicating the second application program and a type of the secondary data generated based on the second application program, and
the in-vehicle device further includes:
an installation unit configured to download the first manifest and the second manifest from the application storage and install the first application program and the second application program; and
a database management unit configured to add a data label to the in-vehicle secondary database based on the first manifest and the second manifest.

12. The vehicle network system according to claim 8, wherein
the utilization status capture unit is configured to acquire secondary data synchronization request information indicating synchronization target data in the secondary data stored in the in-vehicle secondary database,
synchronization of the synchronization target data is requested by each of the first application execution unit and the second application execution unit,
the data synchronization unit uploads the secondary data synchronization request information acquired by the utilization status capture unit to the server secondary database, and
the management server includes
a notification unit configured to
provide notification to the first service server when the secondary data used by the first service server is stored in the server secondary database and
provide notification to the second service server when the secondary data used by the second service server is stored in the server secondary database,
based on the secondary data synchronization request information uploaded to the server secondary database.

13. The vehicle network system according to claim 6, wherein
the management server includes a collection unit configured to collect a utilization record of the secondary data stored in the server secondary database.

14. A vehicle network system comprising:
a management server including a server primary database and a server secondary database;
a first service server configured to provide a first service based on primary data stored in the server primary database or secondary data stored in the server secondary database;
a second service server configured to provide a second service based on the primary data stored in the server primary database or the secondary data stored in the server secondary database; and
an in-vehicle device mounted on a vehicle,
wherein
the in-vehicle device includes:
a primary data acquisition unit configured to acquire the primary data from a control device of the vehicle or an expansion device;
an in-vehicle primary database configured to store the primary data acquired by the primary data acquisition unit;
a first application execution unit configured to
execute a first application program related to the first service based on the primary data stored in the in-vehicle primary database and
request synchronization of a first part of the primary data with the server primary database, the first part being used by the first service server;
a second application execution unit configured to
execute a second application program related to the second service based on the primary data stored in the in-vehicle primary database and
request synchronization of a second part of the primary data with the server primary database, the second part being used by the second service server; and
a data synchronization unit configured to
obtain a logical sum of the first part and the second part according to a primary data synchronization request from the first application execution unit and the second application execution unit, and
upload the logical sum to the server primary database,
the first service server is configured to use the first part stored in the server primary database, and
the second service server is configured to use the second part stored in the server primary database.

15. A data synchronization method comprising:
acquiring primary data from a control device of a vehicle or an expansion device;
storing the acquired primary data in a primary database;
executing a first application program to calculate secondary data from the primary data stored in the primary database;
storing the calculated secondary data in a secondary database; and
executing a second application program to utilize the secondary data stored in the secondary database.

16. The in-vehicle device according to claim 1, further comprising
a processor that serves as the primary data acquisition unit, the first application execution unit, and the second application execution unit.

17. The in-vehicle device according to claim 2, further comprising
a processor that serves as the utilization status capture unit.

18. The vehicle network system according to claim 6, further comprising
a processor that serves as the primary data acquisition unit, the first application execution unit, and the second application execution unit.

19. The vehicle network system according to claim 7, further comprising a processor that serves as the utilization status capture unit.

20. The vehicle network system according to claim 14, further comprising
a processor that serves as the primary data acquisition unit, the first application execution unit, the second application execution unit, and the data synchronization unit.
